(19) United States
(12) Patent Application Publication
(10) Pub. No.: US 2019/0260102 A1
(43) Pub. Date: Aug. 22, 2019

(54) BATTERY MODULE

(71) Applicant: Samsung SDI Co., Ltd., Yongin-si, Gyeonggi-do (KR)

(72) Inventors: Christoph SCHMIEDHOFER, Graz (AT); Helmut RATH, St. Veit / Suedsteiermark (AT)

(21) Appl. No.: 16/342,501

(22) PCT Filed: Oct. 26, 2017
(86) PCT No.: PCT/KR2017/011884

§ 371 Date: Apr. 16, 2019

(30) Foreign Application Priority Data
Oct. 26, 2016 (EP) 16195786.5
Oct. 25, 2017 (KR) 10-2017-0139409

(51) Int. Cl. H01M 10/613; H01M 10/6556; H01M 10/6568; H01M 10/625

(52) U.S. Cl. CPC H01M 10/613; H01M 10/6556; B60L 50/60; H01M 10/625; H01M 2220/20; H01M 10/6568

(57) ABSTRACT

One aspect of the present invention relates to a battery module including a plurality of rechargeable battery cells arranged in a row, a first cooling channel and a second cooling channel that are arranged in one side of the row, and a fluid path plate that is provided between neighboring battery cells, and forms a cooling passage through which a coolant flows from the first cooling channel to the second cooling channel, wherein the fluid path plate includes a guide member that guides the coolant flow from an inlet of the fluid path plate, is communicated with the first cooling channel to an outlet of the fluid path plate, is communicated with the second cooling channel. The guide member includes a plurality of curved ribs and a plurality of circular members connected in a network connection structure. According to the present invention, the cooling passage that generates turbulence with a long cooling route is shared by two neighboring battery cells. Accordingly, a battery module having improved cooling efficiency can be provided.

### CROSS-REFERENCE TO RELATED APPLICATION(S)

This application is a National Phase Patent Application of International Patent Application Number PCT/KR2017/011884, filed on Oct. 26, 2017, which claims priority to European Patent Application No. 16195786.5, filed Oct. 26, 2016 and Korean Patent Application No. 10-2017-0139409, filed Oct. 25, 2017. The entire contents of all of which are incorporated herein by reference.

### TECHNICAL FIELD

The present invention relates to a battery module having a cooling device, and a vehicle including the battery module.

### BACKGROUND ART

Unlike a primary battery, a rechargeable battery can iteratively perform charging and discharging, while the primary battery provides only non-reversible conversion of chemical energy to electrical energy. A rechargeable battery with low capacity is used in a small portable electronic device such as a mobile phone, a notebook computer, and a camcorder, and a rechargeable battery with high capacity may be used as a motor driving power source for a hybrid vehicle and an electric vehicle.

In general, the rechargeable battery includes an electrode assembly that includes a positive electrode, a negative electrode, and a separator disposed between the positive electrode and the negative electrode, a case that receives the electrode assembly, and an electrode terminal that is electrically connected to the electrode assembly. The shape of the case may be changed to any shape such as a cylinder, a rectangle, and the like, depending on the purpose of the battery. An electrolyte solution is injected into the case so that the battery can be charged and discharged through the electrochemical reaction of the positive electrode, the negative electrode, and the electrolyte solution.

The rechargeable battery can be used as a battery module having a plurality of unit battery cells connected in series and/or in parallel so as to provide high-density energy required for driving a motor of a hybrid vehicle and the like. That is, the battery module is formed by connecting electrode terminals of a plurality of battery cells to each other, and by connecting electrode terminals of a plurality of unit cells that conform to the required amount of electrical power to each other, such that a rechargeable battery having a high output for driving a motor can be implemented.

A cell heat management system can cool the rechargeable battery by effectively emitting, discharging, and/or dissipating heat generated from the rechargeable battery for safe use of the battery module. When the heat generated from the battery is not fully emitted, discharged, and/or dissipated, a temperature deviation occurs between battery cells so that one or more battery modules cannot generate a desired amount of power. In addition, when an internal temperature of the rechargeable battery is increased, an abnormal reaction occurs in the rechargeable battery, and then charging/discharging performance of the rechargeable battery is deteriorated, thereby causing shortening of the life space of the rechargeable battery.

As described, a cooling device that is well known in the art effectively emits, discharges, and/or dissipates heat generated from cells. A cooling plate disposed between adjacent (e.g., neighboring) battery cells is one of well-known cooling devices. The cooling plate includes a closed surface having a cooling passage through which a coolant flows. In the cooling plate, the cooling passage is formed only at one side of the cooling plate, and thus opposite sides of the battery cell are unevenly cooled, thereby deteriorating cooling efficiency.

Thus, the purpose of the present invention is to provide a battery module that can solve or reduce the above-stated drawbacks, and has improved cooling efficiency.

### Technical Problem

The present invention provides a battery module that can solve or reduce the above-stated drawbacks, and has improved cooling efficiency.

### Technical Solution

One aspect of the present invention relates to a battery module including a plurality of rechargeable battery cells arranged in a row, a first cooling channel and a second cooling channel that are arranged in one side of the row, and a fluid path plate that is provided between adjacent (e.g., neighboring) battery cells, and forms a cooling passage through which a coolant flows from the first cooling channel toward the second cooling channel, wherein the fluid path plate includes a guide member configured to guide the coolant flow from an inlet of the fluid path plate, is communicated with the first cooling channel to an outlet of the fluid path plate, is communicated with the second cooling channel. The guide member includes a plurality of curved ribs and a plurality of circular members connected in a network connection structure.

The present invention provides the battery module having the fluid path plate to improve cooling efficiency. The curved ribs and circular members turn a direction of coolant flow, thereby generating turbulence. This turbulence minimizes airflow while providing maximum linear velocity at the surface. Thus, turbulence generated from the periphery of the curved ribs and circular members can improve cooling performance. In addition, the plurality of curved ribs and the plurality of circular members are connected with each other through net-shaped supports having a network connection structure, and thus openings may be formed between the curved ribs and the circular members. Accordingly, the coolant path through which the coolant flows to the guide member can be equally shared by battery cells that neighbor at opposite sides thereof. A front side and a rear side of each battery cell can be uniformly cooled, thereby improving cooling efficiency. The plurality of curved ribs and the plurality of circular members can provide a long cooling passage, thereby also improving cooling efficiency. Furthermore, it is possible to provide a stable structure while consuming less material in order to make the net-shaped support.

According to a preferably exemplary embodiment of the present invention, the guide member may further include a center pin so as to extend to a part of the fluid path plate between the inlet and the outlet from a center of the fluid path plate. The center pin can provide mechanical stability through the net-shaped structure of the fluid path plate. The center pin may have a first length, the fluid path plate may extend toward the opposite side of the fluid path plate while having a second length, and a ratio of the first length to the second length may have a range of 1:2 to 1:3. With such a range, stability can be optimized.

Preferably, the center pin may have a rounded tip, and the circular member may be disposed close to the inlet of the fluid path plate. Such a structure increases turbulence in the coolant flow, thereby improving cooling efficiency.

According to a preferable exemplary embodiment of the present invention, the inlet and the outlet may be disposed on a long side of the fluid path plate. Accordingly, a cooling route may be extended.

According to another aspect of the present invention, the battery module may include the housing, and the first cooling channel and the second cooling channel may be disposed in a bottom of the housing. Accordingly, the bottom of the battery cell can be cooled by the coolant, thereby improving cooling efficiency.

According to a preferable exemplary embodiment, the battery cell and the fluid path plate may be formed in the shape of a prism, the guide member may be divided into two parts having the same contour of the fluid path plate, and the two parts may be disposed to be symmetrical to each other with respect to an axis extended from the side where the inlet and the outlet are disposed. Due the symmetrical alignment of the guide member, a length of a cooling passage of one of the two parts of the fluid path plate is the same as a length of a cooling passage of the other one of the fluid path plate. Accordingly, uniform dispersion of the coolant can be assured on the surface of the fluid path plate, thereby improving cooling efficiency.

The battery module preferably further includes a frame that surrounds the fluid path plate. Accordingly, stability of the fluid path plate can be improved.

According to a preferably exemplary embodiment of the present invention, an upper portion of the fluid path plate may be sealed by a sealing member. Thus, the fluid path plate can be sealed from an exhaust gas area provided in the battery cell or the battery module, thereby improving thermal stability. The sealing member is preferably formed of a non-conductive resin member or a steel plate.

According to a preferable exemplary embodiment of the present invention, the battery module includes a plurality of rechargeable battery cells arranged in parallel with each other in a matrix format, and the fluid path plate may be disposed between battery cells that neighbor each other in a row direction. Such a structure can reduce the volume of the battery module and simplify a process of the battery module.

According to another aspect of the present invention, a vehicle including the battery module is provided.

An additional aspect of the present invention can be derived from the dependent claims or the description to be described later.

### Advantageous Effects

According to the exemplary embodiments of the present invention, a cooling passage that generates turbulence with a long cooling route is shared by two adjacent (e.g., neighboring) battery cells, and accordingly, a battery module having improved cooling efficiency can be provided.

### DESCRIPTION OF THE DRAWINGS

In the following detailed description, only certain exemplary embodiments of the present invention have been shown and described, simply by way of illustration.

FIG. 1 is a perspective view of a battery module.

FIG. 2 is a schematic perspective view of a battery cell according to an exemplary embodiment of the present invention.

FIG. 3 is a schematic cross-sectional view of a battery module that uses an active air cooling method according to the exemplary embodiment of the present invention.

FIG. 4 is a schematic perspective view of a housing that supports the active air cooling method according to the exemplary embodiment of the present invention.

FIG. 5 is a perspective view of a flow path according to the exemplary embodiment of the present invention.

FIG. 6 is a schematic perspective view of the flow path connected to the battery cell according to the exemplary embodiment of the present invention.

FIG. 7 is a cross-sectional view of a battery module having a fluid path plate according to another exemplary embodiment.

### MODE FOR INVENTION

Hereinafter, basic features of the present invention and a method for achieving the present invention can be more easily understood by referring to the detailed description of exemplary embodiments and accompanying drawings. Hereinafter, effects and features according to exemplary embodiments of the present invention will be described with reference to the accompanying drawings. The drawings and description are to be regarded as illustrative in nature and not restrictive. Like reference numerals designate like elements throughout the specification. In addition, the expression including “may” is used to describe exemplary embodiments of the present invention, and this implies “at least one or more exemplary embodiments of the present invention.”

Terms such as ‘first’, ‘second’, etc., can be used to describe various elements, but the elements are not construed as being limited to the terms. The terms are only used to differentiate one element from other elements. For example, the first element may be called the second element without departing from the scope of the present disclosure, and similarly, the second element may also be called the first element.

In description of exemplary embodiments of the present invention, a singular expression includes plural expressions as long as the expression does not have apparently different contextual meaning.

In addition, terms such as “comprise” or “include” are used to designate areas, fixed numbers, steps, operations, components, elements, or combinations thereof, but they are not restrictive.

In addition, when referring to one film, region, or element as being “on” or “above” another film, region, or element, it is to be understood that the film, region, or element is disposed directly on the other film, region, or element, or disposed with another film, region, or element therebetween.

When a component or layer is referred to as being connected or coupled to another component or layer, it may be directly connected to another component or layer, or at least one another component or layer may exist between the components. In addition, a component or layer may solely exist between two different components or layers, and at least one intermediate component or layer may be disposed between the components.

Although not specifically defined, all of the terms including the technical and scientific terms used herein have meanings understood by ordinarily skilled persons in the art. The terms have specific meanings coinciding with related technical references and the present specification as well as lexical meanings. That is, the terms are not construed as ideal or formal meanings.

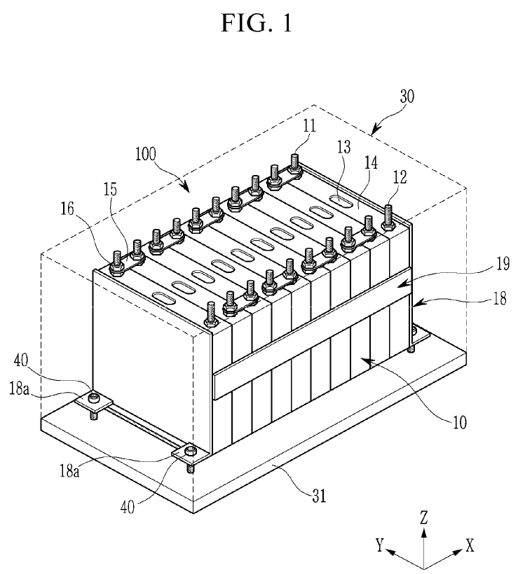

Referring to FIG. 1, according to one exemplary embodiment, a battery module 100 includes a plurality of battery cells 10 that are arranged in one direction. A pair of end plates 18 are provided to face a side surface of the battery cell 10 at the outside of the battery cell 10, and a connection plate 19 connects the pair of end plates 18 to fix the plurality of battery cells 10 together. Fastening portions 18a formed at opposite sides of the battery module 100 are fixed to a support plate 31 through bolts 40. The support plate 31 is a part of a housing 30. The battery module 100 includes a bus bar 15 that electrically connects positive terminals 11 and negative terminals 12 of adjacent (e.g., neighboring) battery cells 10, and the bus bar 15 may be fixed by using a nut 16 and the like.

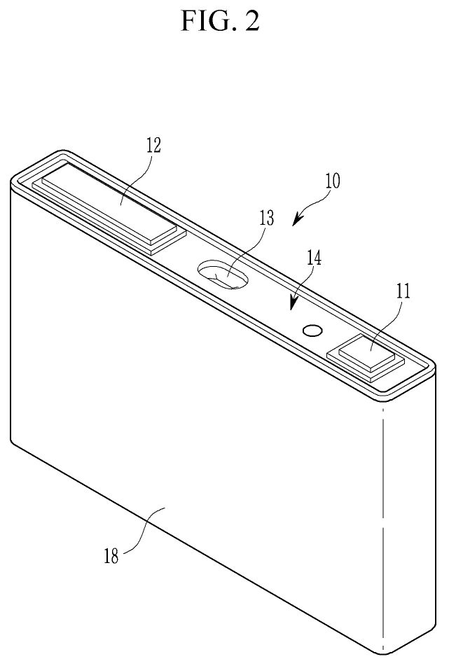

Referring to FIG. 2, each battery cell 10 is a prism-shaped (or quadrangular-shaped) cell, and a wide plane of each cell is layered such that the battery module 100 may be formed. A battery case 18 is closed and sealed by a cap assembly 14. The cap assembly 14 is provided with a positive terminal 11, a negative terminal 12, and a vent 13. The positive terminal 11 and the negative terminal 12 have different polarities. The vent 13, which is a safety means of the battery cell 10, functions as a path through which a gas generated from the battery cells 10 is discharged to the outside. As shown in FIG. 1, positive terminals 11 and negative terminals 12 of adjacent (e.g., neighboring) battery cells 10 are electrically connected through the bus bar 15. Thus, the battery module 100 may be used as a power device by electrically connecting the plurality of battery cells 10 as a bundle.

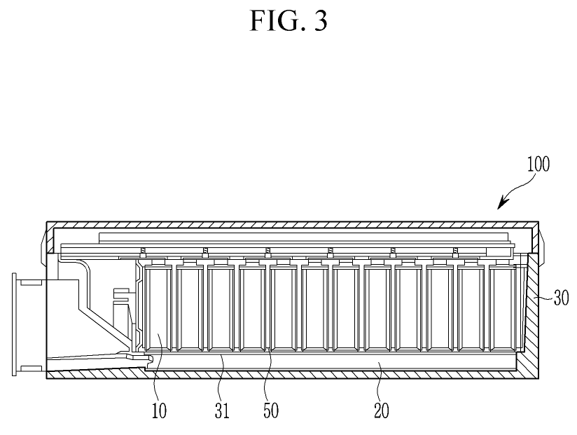

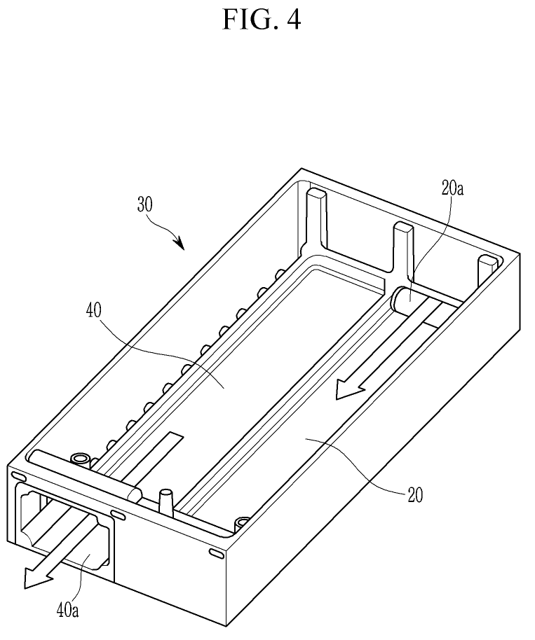

FIG. 3 is a schematic perspective view of the battery module 100 according to the exemplary embodiment of the present invention, and FIG. 4 is a schematic perspective view of the housing 3 according to the exemplary embodiment of the present invention.

The plurality of aligned battery cells 10 are arranged along one row, and a fluid path plate 50 is disposed between adjacent (e.g., neighboring) battery cells 10. The battery module 100 further includes a first cooling channel 20 and a second cooling channel 40 that are arranged at the same side in one row. As shown in FIG. 4, a coolant is introduced through an inlet 20a of the first cooling channel 20, and flows to an outlet 40a of the second cooling channel 40. Specifically, the coolant is introduced into the fluid path plate 50 from the first cooling channel 20 and introduced into the second cooling channel 40 from the fluid path plate 50. Thus, the fluid path plate 50 forms a cooling passage through which the coolant flows to the outlet 40a of the second cooling channel 40 from the inlet 20a of the first cooling channel 20. The fluid path plate 50 is disposed between the battery cells 10, and the coolant passes therethrough such that the battery cells 10 are cooled. The coolant may be air, but this is not restrictive.

The battery module 100 may further include the housing 30 that surrounds the battery module 100, and the support plate 31. As shown in FIG. 4, the first cooling channel 20 and the second cooling channel 40 may be disposed at the bottom of the housing 30. Accordingly, bottoms of the battery cells 10 can be cooled by the coolant.

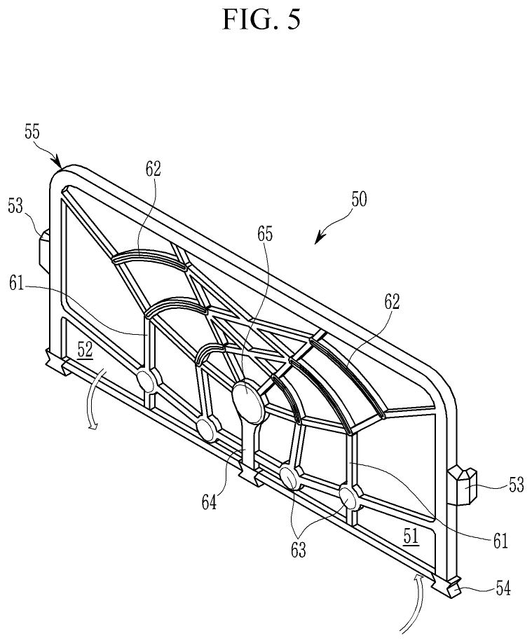

FIG. 5 is a perspective view of the fluid path plate 50 according to the exemplary embodiment of the present invention. As shown in FIG. 5, the fluid path plate 50 includes an inlet 51 and an outlet 52 of the coolant. The inlet 51 of the fluid path plate 50 is communicated with the first cooling channel 20 through a gap between the battery cell 10 and the fluid path plate 50. Thus, the coolant flows to the fluid path plate 50 through the inlet 51 in the first cooling channel 20. As shown in FIG. 5, the coolant that flows through the inlet 51 of the fluid path plate 50 is guided by a guide member formed on the fluid path plate 50, and thus flows toward the outlet 52 of the fluid path plate 50. The outlet 52 of the fluid path plate 50 is communicated with the second cooling channel 40 through a gap between the battery cell 10 and the fluid path plate 50. Thus, the coolant flows toward the second cooling channel 40 from the outlet 52 of the fluid path plate 50.

The fluid path plate 50 of the present invention may further include side protrusions 53 and lower supports 54 that are connected with the battery cell 10. The side protrusions 53 may be connected to the battery cell 10 with a hinge structure, and the lower supports 54 may be welded to the support plate 31 of the housing 30. However, the present invention is not limited thereto.

According to the exemplary embodiment of the present invention, the inlet 51 and the outlet 52 of the fluid path plate 50 may be disposed on a long side of a prism-shaped fluid path plate 50. Here, a length of the long sides of the fluid path plate 50 is longer than a length of the other two sides of the fluid path plate. However, the present invention is not limited thereto. The inlet port 51 and the outlet port 52 of the fluid path plate 50 may be disposed at any positions that can be communicated with the first cooling channel 20 and the second cooling channel 40, respectively.

As shown in FIG. 5, the guide member of the fluid path plate 50 of the present invention includes a plurality of curved ribs 62 and a plurality of circular members 63. The curved ribs 62 and the circular members 63 rotate a coolant flow to cause turbulence. As is well known, turbulence enhances cooling performance. Thus, ribs and circular members having various structures for flow of the coolant can be applied to the fluid path plate 50 of the present invention. The circular member 63 may be implemented as a circular-shaped disk or an oval-shaped disk. The circular member 63 can be provided close to the inlet 51 and/or outlet 52 of the fluid path plate 50. Accordingly, cooling efficiency can be improved.

As shown in FIG. 5, the plurality of curved ribs 62 and the plurality of circular members 63 are connected with each other through net-shaped supports 61. The term, “net-shaped” implies a structure having a connection portion that connects one opening and another opening. Through the openings of the net-shaped supports 61, the coolant path through which the coolant flows can be shared by adjacent (e.g., neighboring) battery cells 10, and a front side and a rear side of each battery cell 10 can be cooled.

As shown in FIG. 5, the battery module 100 according to the present invention may include a frame 55 that surrounds the guide member, and the guide member may include a center pin 64. The frame 55 and the center pin 64 provide mechanical stability in a network connection structure of the fluid path plate 50. As shown in FIG. 5, the center pin 64 extends toward a center of the fluid path plate 50 from the bottom of the fluid path plate 50. The center pin 64 preferably extends from a center of the bottom of the fluid path plate 50 to assure uniform flow of the coolant in the fluid path plate 50, while improving mechanical stability, but the present invention is not limited thereto. The center pin 64 may be extended from other places between the inlet 51 and the outlet 52 of the fluid path plate 50 as long as the fluid path plate 50 can be stably supported. A length of the center pin 64 is determined not only for improving stability of the fluid path plate 50 but also for uniform dispersion of the coolant. It is preferable that a ratio of the length of the center pin 64 and the bottom length of the flow path plate 50 is in a range of 1:2 to 1:3. As shown in FIG. 5, the center pin 64 may have a rounded tip 65. The rounded tip 65 also generates turbulence.

The guide member is divided into two parts, each having the same contour as the fluid path plate 50, and the two parts may be arranged to be symmetrical to each other with respect to an axis extended from a side where the inlet 51 and the outlet 52 are disposed.

Due the symmetrical alignment of the guide member, a length of a cooling passage of one of the two parts of the fluid path plate 50 is the same as a length of a cooling passage of the other part of the fluid path plate 50. Accordingly, uniform dispersion of the coolant can be assured on the surface of the fluid path plate 50, thereby improving cooling efficiency.

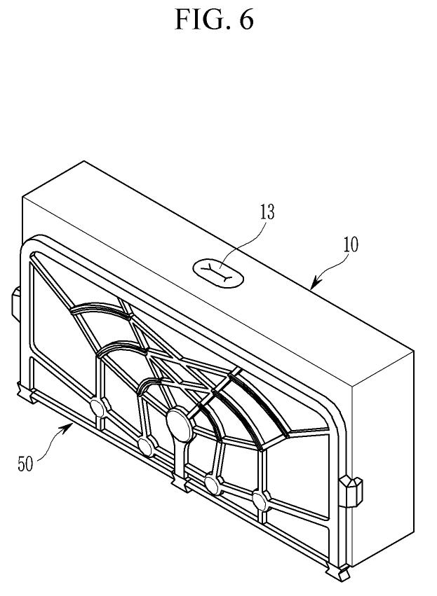

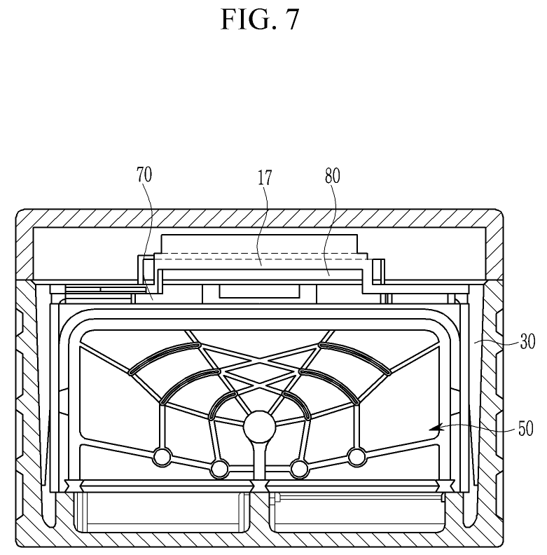

FIG. 6 schematically illustrates the flow path 50 connected to the battery cell 10 according to the exemplary embodiment of the present invention. As shown in FIG. 6, an upper portion of the fluid path plate 50 may be sealed by a sealing member 70 (refer to FIG. 7). Here, the upper portion of the fluid path plate 50 may be a side that opposes a side (i.e., a lower side) of the fluid path plate 50, in which the inlet 51 and the outlet 52 are disposed. As described above, the battery cell 10 includes a vent 13, which is a safety means serving as a path for discharging a gas generated from the battery cell 10 to the outside of the battery cell 10. The discharged gas flows through an exhaust gas area in general, and the exhaust gas area may be provided in the housing 30 of the battery cell 10 and/or the bus bar 15 that connects the plurality of battery cells 10. According to the present invention, the fluid path plate 50 may be sealed by the sealing member 70 in the exhaust gas area so that stability with respect to heat can be improved. The sealing member 70 may be a non-conductive resin member or a steel plate, but the present invention is not limited thereto.

FIG. 7 is a cross-sectional view of a battery module 100 provided with a fluid path plate 50 according to another exemplary embodiment of the present invention. As previously described, the fluid path plate 50 is disposed between adjacent (e.g., neighboring) battery cells 10 that are arranged in a row. In the present exemplary embodiment, an upper portion of the fluid path plate 50 may be sealed by a sealing member 70, and an exhaust gas area 80 may be provided at the periphery of a bus bar carrier 17 where a bus bar that connects two battery cells 10 is provided. When high thermal stress is applied to the rechargeable battery cell 10, the rechargeable battery cell 10 may be ruptured, thereby generating a considerable amount of flammable and noxious gas. When the rechargeable battery cell 10 is applied to a vehicle, permeation of gas into a passenger compartment should be prevented. For this, in a cooling system, an exhaust gas area sealed from cooling channels 20 and 40 is provided on the battery cell.

According to the present invention, a cooling passage that has a long cooling route and generates turbulence is equally shared by two adjacent (e.g., neighboring) battery cells. Thus, a battery module having improved cooling efficiency can be provided. Further, coolant flow can be evenly dispersed to the fluid path plate 50 by the cooling passages that are symmetrically arranged on the fluid path plate.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

-Description of symbols-

| | |
|---|---|
| 10: battery cell | 53: side protrusion |
| 100: battery module | 54: lower support |
| 13: vent | 55: frame |
| 15: bus bar | 61: net-shape support |
| 20, 40: first and second cooling channel | 62: rib |
| 30: housing | 63: circular member |
| 31: support plate | 64: center pin |
| 50: fluid path plate | 65: rounded tip |
| 51: inlet | 70: sealing member |
| 52: outlet | 80: exhaust gas area |

1. A battery module comprising:
a plurality of rechargeable battery cells arranged in a row;
a first cooling channel and a second cooling channel that are arranged in one side of the row; and
a fluid path plate that is provided between adjacent ones of the battery cells, and forms a cooling passage through which a coolant flows from the first cooling channel to the second cooling channel,
wherein the fluid path plate comprises a guide member configured to guide the coolant flow from an inlet of the fluid path plate, is communicated with the first cooling channel to an outlet of the fluid path plate, is communicated with the second cooling channel, and
the guide member comprises a plurality of curved ribs and a plurality of circular members connected in a network connection structure.

2. The battery module of claim 1, wherein the guide member further comprises a center pin that extends toward a center of the fluid path plate from a part of the fluid path plate, which is disposed between the inlet and the outlet of the fluid path plate.

3. The battery module of claim 2, wherein the center pin comprises a rounded tip.

4. The battery module of claim 2, wherein the center pin has a first length,
the fluid path plate extends toward the outlet from the inlet while having a second length, and
a ratio of the first length to the second length has a range of 1:2 to 1:3.

5. The battery module of claim 1, wherein the circular member is disposed close to the inlet and/or outlet.

6. The battery module of claim 1, wherein the inlet and the outlet of the fluid path plate are disposed on a long side of the fluid path plate.

7. The battery module of claim 1, comprising a housing in which the first cooling channel and the second cooling channel are disposed in a bottom thereof.

8. The battery module of claim 1, wherein the battery cell and the fluid path plate are formed in the shape of a prism.

9. The battery module of claim 8, wherein the guide member is divided into two parts having the same contour of the fluid path plate, and the two pars are disposed to be symmetrical to each other with respect to an axis extended from the side where the inlet and the outlet are disposed.

10. The battery module of claim 1, further comprising a frame that surrounds the fluid path plate.

11. The battery module of claim 1, wherein an upper portion of the fluid path plate is sealed by a sealing member.

12. The battery module of claim 11, wherein the sealing member comprises a non-conductive resin member or a steel plate.

13. The battery module of claim 11, further comprising an exhaust gas area on the sealing member.

14. A vehicle comprising the battery module of claim 1.
